(19) United States
(12) Patent Application Publication
(10) Pub. No.: US 2013/0056571 A1
(43) Pub. Date: Mar. 7, 2013

(54) SEAT BELT PRETENSIONER FOR VEHICLE AND METHOD FOR PROTECTING PASSENGER USING THE SAME

(71) Applicants: Hae Ryong Choi, Seoul (KR); Chang Ky Kang, Hwaseong-si (KR)

(72) Inventors: Hae Ryong Choi, Seoul (KR); Chang Ky Kang, Hwaseong-si (KR)

(73) Assignee: Hyundai Motor Company, Seoul (KR)

(21) Appl. No.: 13/316,533

(22) Filed: Dec. 11, 2011

(30) Foreign Application Priority Data
Sep. 6, 2011 (KR) 10-2011-0090213

(51) Int. Cl. B60R 22/46

(52) U.S. Cl. 242/374

(57) ABSTRACT

A seat belt pretensioner apparatus for a vehicle may include a motor operated in response to a control signal of a seat-belt controller, a reduction gear transmitting a rotating force of the motor, and a rotary roll rotated by a rotating force transmitted from the reduction gear, an end of a seat belt being coupled to the rotary roll.

### CROSS-REFERENCE TO RELATED APPLICATION

The present application claims priority to Korean Patent Application No. 10-2011-0090213, filed on Sep. 6, 2011 the entire contents of which is incorporated herein for all purposes by this reference.

### BACKGROUND OF THE INVENTION

1. Field of the Invention

The present invention relates generally to a seat belt pretensioner for a vehicle and a method for protecting a passenger using the pretensioner and, more particularly, to a pretensioner implemented as a motor gear structure to be used semi-permanently and a method for protecting a passenger using the pretensioner.

2. Description of Related Art

As shown in FIG. 1, a seat 1 of a vehicle is provided with a seat belt 2 that restrains an upper body of a passenger to protect the passenger in the event of a collision. The seat belt 2 is configured to be operated together with a pretensioner 10.

That is, the pretensioner 10 functions to momentarily rewind the seat belt 2 in the event of a collision. The restraining force of the seat belt 2 prevents the upper body of the passenger from being propelled forwards, thus further improving the function of the seat belt 2.

The conventional pretensioner 10 is activated using the explosive power of gunpowder. As shown in the drawing, the pretensioner 10 includes a gunpowder chamber 11 for storing gunpowder, a motor 12, a reduction gear 13, and a rotary roll 14.

However, the conventional pretensioner 10 using gunpowder is problematic because it is impossible to reuse the pretensioner 10 once it has been used, thus making it very expensive. Especially, the operation of a load limiter for gradually loosening the seat belt 2 after the operation of the pretensioner 10 is not precisely controlled for the specific impact that occurs, which undesirably increases the shock exerted on a passenger.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a seat belt pretensioner for a vehicle and a method for protecting a passenger using the pretensioner, in which the pretensioner is implemented as a motor gear structure to be used semi-permanently, thus reducing the cost and minimizing the shock administered to the passenger by controlling the torque of a motor.

In an aspect of the present invention, the seat belt pretensioner apparatus for a vehicle may include a motor operated in response to a control signal of a seat-belt controller, a reduction gear transmitting a rotating force of the motor, and a rotary roll rotated by a rotating force transmitted from the reduction gear, an end of a seat belt being coupled to the rotary roll.

The motor may generate a maximum torque to prevent the seat belt from becoming loose when a maximum load acting on the seat belt is detected by a seat-belt load sensor.

The seat-belt controller may control the torque of the motor to be reduced to enable an operation of a load limiter after a passenger may have been restrained by the seat belt.

The seat-belt controller may control the torque of the motor to eliminate a tensile force from the seat belt so as to allow the passenger to easily loosen the seat belt after an operation of the load limiter.

The rotary roll is installed to axially rotate relative to a housing, and a return spring is coupled at opposite ends thereof to the rotary roll and the housing to provide an elastic restoring force to rotation of the rotary roll.

The reduction gear and the rotary roll are coupled to each other to transmit power via a sleeve, and a first end of the sleeve is provided with a coupling shaft coupled with the reduction gear, and a second end of the sleeve is spline-coupled with the rotary roll.

In another aspect of the present invention, a method for protecting a passenger using a seat belt pretensioner apparatus for a vehicle, may include generating torque by a motor operated in response to a control signal of a seat-belt controller when a collision signal is detected, generating a maximum torque of the motor to prevent a seat belt from becoming loose when a maximum load acts on the seat belt, and reducing the torque of the motor to enable an operation of a load limiter after the passenger may have been restrained by the seat belt.

The method may further include eliminating an amount of slackness in the seat belt by an initial operation of the motor when the motor is operated in response to the control signal of the seat-belt controller.

The method may further include eliminating a tensile force from the seat belt by further reducing the torque of the motor to allow the passenger to easily loosen the seat belt after an operation of the load limiter.

The seat belt pretensioner according to various aspects of the present invention is advantageous in that it is configured to perform both a pretensioning function and a load limiter function using a motor and a reduction gear, thus enabling semi-permanent use, remarkably reducing the cost, and minimizing the shock administered to a passenger by controlling the torque of the motor, therefore more safely protecting the passenger.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a conventional seat belt pretensioner.

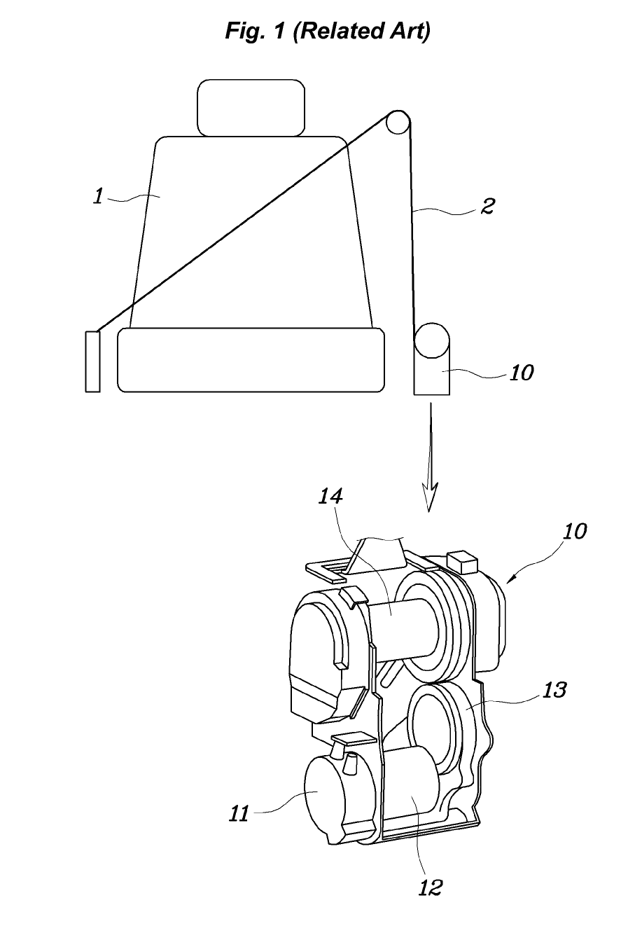

FIG. 2 is a view illustrating a seat belt pretensioner in accordance with the present invention.

FIG. 3 is an exploded perspective view illustrating components of the seat belt pretensioner in accordance with the present invention.

FIG. 4 is a flowchart illustrating a method for protecting a passenger using the seat belt pretensioner in accordance with the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a seat belt pretensioner for a vehicle and a method for protecting a passenger using the pretensioner according to a exemplary embodiment of the present invention will be described with reference to the accompanying drawings.

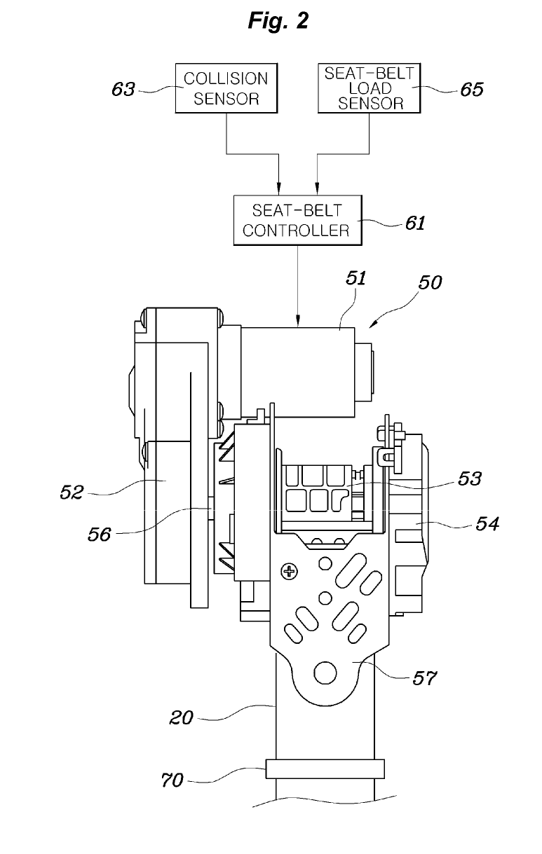

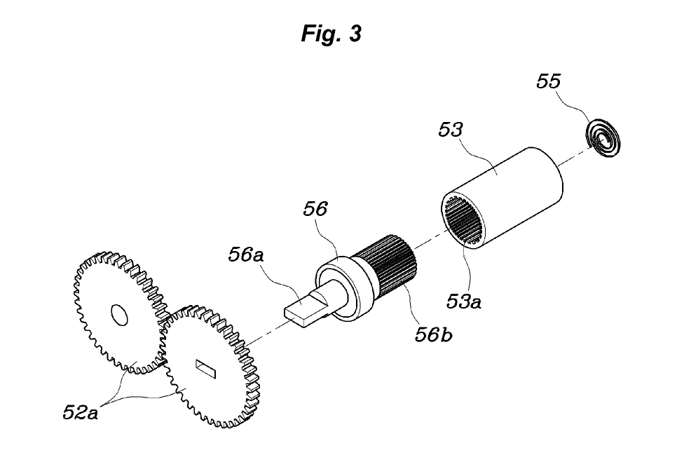

As shown in FIGS. 2 and 3, the seat belt pretensioner 50 according to an exemplary embodiment of the present invention that uses a motor to perform a pretensioning function and a load limiter function includes a motor 51, a reduction gear 52, and a rotary roll 53. The motor 51 is operated in response to a control signal of a seat-belt controller 61. The reduction gear 52 transmits a rotating force of the motor 51. The rotary roll 53 is rotated by a rotating force transmitted from the reduction gear 52.

The seat-belt controller 61 is basically configured to receive signals from a collision sensor 63 and a seat-belt load sensor 65.

The collision sensor 63 is a sensor for detecting a situation when a collision occurs. The seat-belt load sensor 65 is a sensor for detecting a load exerted on a seat belt 20 by a passenger's upper body that is moved by an inertial force in the event of a collision.

One end of the seat belt 20 is coupled to the rotary roll 53. When the rotary roll 53 rotates, the seat belt 20 is wound around or unwound from the rotary roll 53.

The rotary roll 53 is installed to axially rotate relative to a housing 54.

Further, the pretensioner further includes a return spring 55 that is coupled at opposite ends thereof to the rotary roll 53 and the housing 54 to provide an elastic restoring force to the rotation of the rotary roll 54.

Meanwhile, the reduction gear 52 includes a plurality of gear members 52a. The reduction gear 52 and the rotary roll 53 are coupled to each other to transmit power via a sleeve 56.

To this end, one end of the sleeve 56 is provided with a coupling shaft 56a to be coupled with any one of the gear members 52a constituting the reduction gear 52. The other end of the sleeve 56 is spline-coupled with the rotary roll 53.

In order to spline-couple the sleeve 56 with the rotary roll 53, a plurality of splines 56b may be formed on an outer circumference of the other end of the sleeve 56 in such a way as to extend in a longitudinal direction of the sleeve 56, and splines 53a may be also formed on an inner circumference of the rotary roll 53 in such a way as to correspond to the splines 56b. However, the present invention is not limited to such a coupling structure.

Further, reference numeral 57 shown in FIG. 2 is a retractor whose purpose is to automatically wind the seat belt 20 around the rotary roll 53 when the seat belt 20 is loosened.

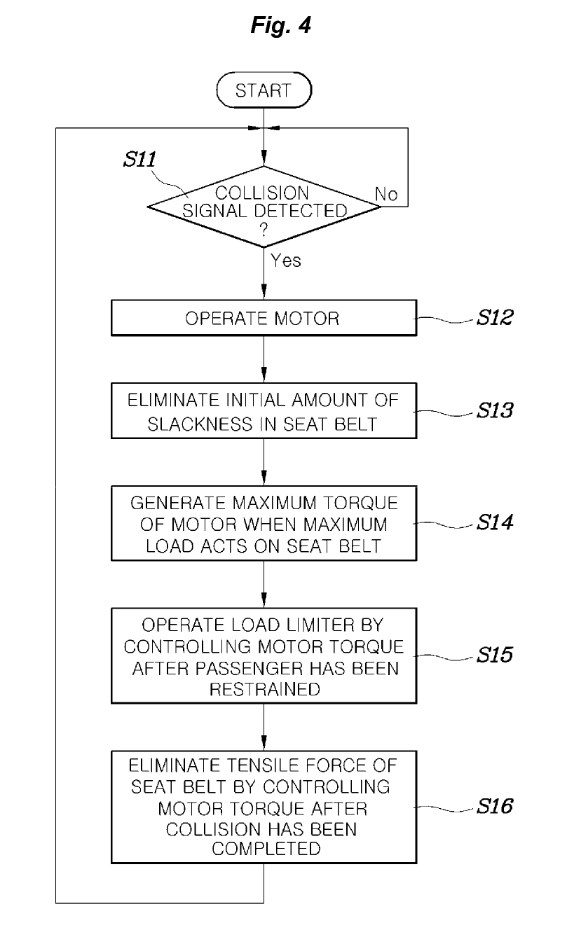

The method for protecting the passenger using the seat belt pretensioner for the vehicle according to an exemplary embodiment of the present invention will be described together with the operation of the present invention with reference to FIGS. 2 to 4.

If the collision sensor 63 detects a collision signal at step S11 and transmits the collision signal to the seat-belt controller 61, the motor 51 is operated in response to a control signal of the seat-belt controller 61, so that torque is generated at step S12.

At this time, as the amount of slackness in the seat belt 20 is eliminated by the torque generated during an initial operation of the motor 51, a passenger sitting on a seat is stably restrained by the seat belt 20 at step S13.

When the amount of slackness in the seat belt 20 is eliminated and the force of the passenger's upper body pressing the seat belt 20 is at a maximum because of the inertial force in the event of a collision, that is, when a maximum load acts on the seat belt 20, the motor 51 generates a maximum torque under the control of the seat-belt controller 61. Thereby, the seat belt 20 is prevented from loosening, so that the passenger's upper body can be stably restrained at step S14.

In an exemplary embodiment of the present invention, the maximum load is detected by the seat-belt load sensor 65.

Further, after the passenger has been restrained, the torque of the motor 51 is gradually reduced under the control of the seat-belt controller 61. Thereby, the load limiter 70 is operated to gradually loosen the seat belt 20 at step S15.

The load limiter 70 is operated while the rotary roll 52 turns two or three times to unwind the seat belt 20 therefrom.

Further, after the load limiter 70 has been operated, that is, the collision has completed, the passenger must easily loosen and escape from the seat belt 20. To this end, the torque of the motor 51 is further reduced under the control of the seat-belt controller 61, thus resulting in the release of the tensile force of the seat belt 20 at step S16.

Therefore, the passenger can easily loosen and get out of the seat belt 20 from which the tensile force was released.

As described above, the present invention provides a seat belt pretensioner, which can sufficiently perform a pretensioning function and a load limiter function using a motor 51 and a reduction gear 52 without using gunpowder, thus enabling semi-permanent use and remarkably reducing the cost.

Further, the present invention provides a seat belt pretensioner, which can minimize shock administered to a passenger by controlling the torque of a motor 51, thus more safely protecting the passenger.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A seat belt pretensioner apparatus for a vehicle, comprising:
a motor operated in response to a control signal of a seat-belt controller;
a reduction gear transmitting a rotating force of the motor; and
a rotary roll rotated by a rotating force transmitted from the reduction gear, an end of a seat belt being coupled to the rotary roll.

2. The seat belt pretensioner apparatus as set forth in claim 1, wherein the motor generates a maximum torque to prevent the seat belt from becoming loose when a maximum load acting on the seat belt is detected by a seat-belt load sensor.

3. The seat belt pretensioner apparatus as set forth in claim 2, wherein the seat-belt controller controls the torque of the motor to be reduced to enable an operation of a load limiter after a passenger has been restrained by the seat belt.

4. The seat belt pretensioner apparatus as set forth in claim 3, wherein the seat-belt controller controls the torque of the motor to eliminate a tensile force from the seat belt so as to allow the passenger to easily loosen the seat belt after an operation of the load limiter.

5. The seat belt pretensioner apparatus as set forth in claim 1, wherein the rotary roll is installed to axially rotate relative to a housing, and a return spring is coupled at opposite ends thereof to the rotary roll and the housing to provide an elastic restoring force to rotation of the rotary roll.

6. The seat belt pretensioner apparatus as set forth in claim 1, wherein the reduction gear and the rotary roll are coupled to each other to transmit power via a sleeve, and
a first end of the sleeve is provided with a coupling shaft coupled with the reduction gear, and
a second end of the sleeve is spline-coupled with the rotary roll.

7. A method for protecting a passenger using a seat belt pretensioner apparatus for a vehicle, comprising:
generating torque by a motor operated in response to a control signal of a seat-belt controller when a collision signal is detected;
generating a maximum torque of the motor to prevent a seat belt from becoming loose when a maximum load acts on the seat belt; and
reducing the torque of the motor to enable an operation of a load limiter after the passenger has been restrained by the seat belt.

8. The method as set forth in claim 7, further including:
eliminating an amount of slackness in the seat belt by an initial operation of the motor when the motor is operated in response to the control signal of the seat-belt controller.

9. The method as set forth in claim 7, further including:
eliminating a tensile force from the seat belt by further reducing the torque of the motor to allow the passenger to easily loosen the seat belt after an operation of the load limiter.
